(19) United States
(12) Patent Application Publication
(10) Pub. No.: US 2022/0397667 A1
(43) Pub. Date: Dec. 15, 2022

(54) ULTRASONIC SENSOR FOR VEHICLE AND METHOD FOR CONTROLLING THE SAME

(71) Applicant: HYUNDAI MOBIS CO., LTD., Seoul (KR)

(72) Inventor: Tae Ho LEE, Yongin-si (KR)

(73) Assignee: HYUNDAI MOBIS CO., LTD., Seoul (KR)

(21) Appl. No.: 17/661,542

(22) Filed: Apr. 29, 2022

(30) Foreign Application Priority Data
Jun. 14, 2021 (KR) 10-2021-0076808

(51) Int. Cl. G01S 15/931

(52) U.S. Cl. CPC G01S 15/931

(57) ABSTRACT

A vehicle ultrasonic sensor and a method of controlling the sensor, the sensor including an ultrasonic transceiver; a storage unit; and a control unit determining a distance to a target based on a transmitted and received ultrasonic wave and judging a detected target to be a proximate target within a certain distance from the ultrasonic transceiver when a ring time of the received ultrasonic wave exceeds a normal ring time in the storage unit.

### CROSS REFERENCE TO RELATED APPLICATION

The present application claims priority to Korean Patent Application No. 10-2021-0076808, filed Jun. 14, 2021, the entire contents of which is incorporated herein for all purposes by this reference.

### BACKGROUND OF THE INVENTION

### Field of the Invention

The present invention relates to an ultrasonic sensor for a vehicle and a control method thereof that allow accurate recognition of a target and calculation of a distance to the target through an analysis of an ultrasonic sensor ring time and prevention of an erroneous recognition by distinguishing causes of increased ring time even when the target is located in proximity.

### Description of the Related Art

In general, detection sensors such as ultrasonic sensors are mounted on bumpers, grilles, and doors on the front, rear, and sides, or either the front or the rear, of a vehicle to detect objects or obstacles during parking or pulling over.

The vehicle detection sensor uses an element having piezoelectric and electrostrictive characteristics as a vibration source. In particular, the sensor based on a piezoelectric element senses using ultrasonic waves, and fast vibrations of the same number as the frequency are generated when high-frequency electrical energy is applied to the piezoelectric element.

At this time, when the frequency applied to the piezoelectric element is equal to or greater than 20 kHz, the piezoelectric element generates, by vibration, an ultrasonic wave having a specific frequency band inaudible to human ears. That is, by intermittently transmitting ultrasonic pulse signals and receiving reflected waves from an obstacle existing in the surroundings, the object and obstacle are detected.

In particular, a parking assistance system for a vehicle mainly uses an ultrasonic sensor. When an ultrasonic wave is transmitted from an ultrasonic sensor and this waveform hits an object and returns, the same sensor receives the wave to calculate the distance between the sensor and the object using the time difference between transmission and reception (the property that the ultrasonic wave travels at 340 m/s is used).

An integrated transceiver sensor is used as a vehicle ultrasonic sensor in general. That is, transmission and reception are performed by the same sensor such that a unique residue of the transmitted ultrasonic wave remains in the transceiver after the ultrasonic wave is transmitted so that, even when a returned wave is received, the received wave may not be accurately distinguished from the residue of the transmitted wave until the residue disappears. Accordingly, the problem is that object detection is difficult for a certain time (approximately 1.5 ms to 2.0 ms, or 20 cm to 30 cm) in which the residue disappears.

Accordingly, there is a need for a technology that allows relatively accurate distinction and detection of a target even in an interval where the transmission and reception overlap, that is, at a short distance, while using a transceiver into which transmission and reception are integrated.

The matters described above as a technical background are intended only for a better understanding of the background of the present invention and are not to be taken as acknowledgment that they pertain to the conventional art already known to those skilled in the art.

### SUMMARY OF THE INVENTION

The present invention is proposed to address the issue described above, and an object of the present invention is to provide a vehicle ultrasonic sensor and a control method thereof that allows an accurate recognition of a target, calculation of a distance to the target, and prevention of an erroneous recognition by distinguishing the causes of increased ring time through an analysis of an ultrasonic sensor ring time even when the target is located in proximity.

According to the present invention, the vehicle ultrasonic sensor for achieving the object described above includes an ultrasonic transceiver; a storage unit storing a normal ring time of a received ultrasonic wave; and a control unit determining a distance to the target based on the transmitted and received ultrasonic wave and judging the detected target to be a proximate target within a certain distance from the ultrasonic transceiver when the ring time of the received ultrasonic wave is greater than the normal ring time in the storage unit.

The control unit may monitor the ring time upon receiving the ultrasonic wave and continuously compare the monitored ring time with the normal ring time in the storage unit.

When the ring time of the ultrasonic wave received while the vehicle is on the move is greater than the normal ring time in the storage, the control unit may recognize the ultrasonic wave received after the ring time as an N-th reflected wave.

The control unit may estimate the distance to the target based on the N-th reflected wave received after the ring time.

A plurality of ultrasonic transceivers may be provided at a plurality of points in the vehicle, and the control unit may recognize the ultrasonic wave received after the ring time as the N-th reflected wave for the ultrasonic transceiver mounted on a surface of a certain area or more among the plurality of ultrasonic transceivers.

A plurality of ultrasonic transceivers may be provided at a plurality of points in the vehicle, and the control may recognize the ultrasonic wave received after the ring time as an N-th reflected wave for an ultrasonic transceiver mounted on a surface of a certain area including a door or a bumper among the plurality of ultrasonic transceivers.

The ultrasonic sensor of the present invention further includes a monitoring unit monitoring the frequency or impedance of the ultrasonic transceiver or the operating environment, wherein, when the ultrasonic transceiver or the operating environment is determined to be normal based on the information of the monitoring unit, the control unit may determine the detected target to be a proximate target within a certain distance from the ultrasonic transceiver when the ring time of the ultrasonic wave is greater than the normal ring time.

The storage unit may store a normal resonant frequency and a normal impedance of the ultrasonic transceiver, and the control unit may determine whether the ultrasonic transceiver is normal based on the comparison between a resonant frequency and an impedance of the ultrasonic transceiver monitored through the monitoring unit and the normal resonant frequency and the normal impedance.

The storage unit may be provided with a data map concerning the temperature and the normal ring time, and the control unit may obtain the normal ring time through the data map at the temperature monitored through the monitoring unit and determine whether the operating environment is normal based on the comparison between the obtained normal ring time and the ring time of the ultrasonic wave.

A method of controlling the ultrasonic sensor of the present invention includes transmitting an ultrasonic wave through an ultrasonic transceiver; receiving an ultrasonic wave through the ultrasonic transceiver; calculating, by a control unit, a ring time of the received ultrasonic wave; comparing the ring time calculated by the control unit with a normal ring time stored in a storage unit; and determining a detected target to be a proximate target within a certain distance from the ultrasonic transceiver when the ring time calculated by the control unit is greater than the normal ring time.

In the determining of a detected target to be the proximate target, the control unit may recognize the ultrasonic wave received after the ring time as the N-th reflected wave when the ring time of the ultrasonic wave received while the vehicle is on the move is greater than the normal ring time in the storage unit.

The control unit may estimate the distance to the target through the N-th reflected wave received after the ring time.

In the determining of the proximate target, the control unit may determine the detected target to be the proximate target within a certain distance from the ultrasonic transceiver when the ultrasonic transceiver or the operating environment is normal and the ring time of the ultrasonic wave exceeds the normal ring time.

The control unit may determine whether the ultrasonic transceiver is normal based on the comparison between the resonant frequency and impedance of the ultrasonic transceiver and the normal resonant frequency and normal impedance.

The control unit may obtain the normal ring time at the temperature measured through the data map and determine whether the operating environment is normal by comparing the obtained normal ring time with the ring time of the ultrasonic wave.

According to the ultrasonic sensor for the vehicle and the control method thereof of the present invention, an analysis of the ultrasonic sensor ring time allows accurate recognition of a target, calculation of a distance to the target and prevention of an erroneous recognition by distinguishing causes of the increased ring time even when the target is located in proximity.

### BRIEF DESCRIPTION OF THE DRAWINGS

FIG. 1 is a view illustrating a configuration of a vehicle ultrasonic sensor according to an embodiment of the present invention.

FIGS. 2 and 3 are views illustrating a general detecting process by a vehicle ultrasonic sensor and a control method thereof according to an embodiment of the present invention.

FIGS. 4 and 5 are views illustrating a process of detecting a proximate target by a vehicle ultrasonic sensor and a control method thereof according to an embodiment of the present invention.

FIG. 6 is a flowchart of a control method of a vehicle ultrasonic sensor according to an embodiment of the present invention.

### DETAILED DESCRIPTION OF THE INVENTION

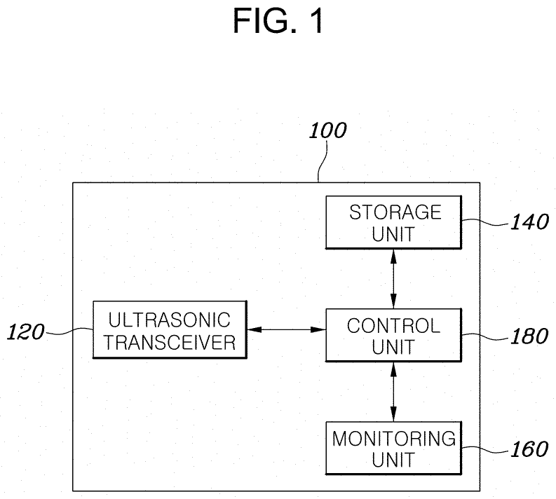

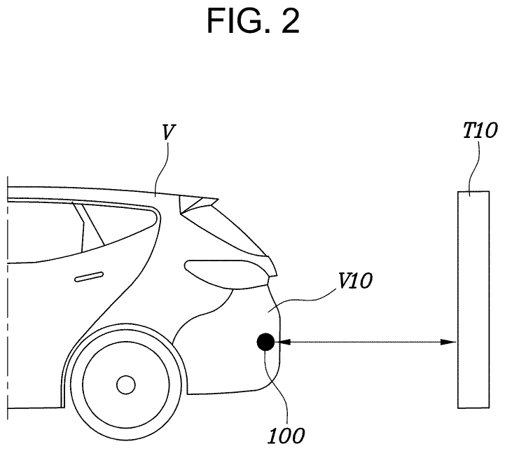

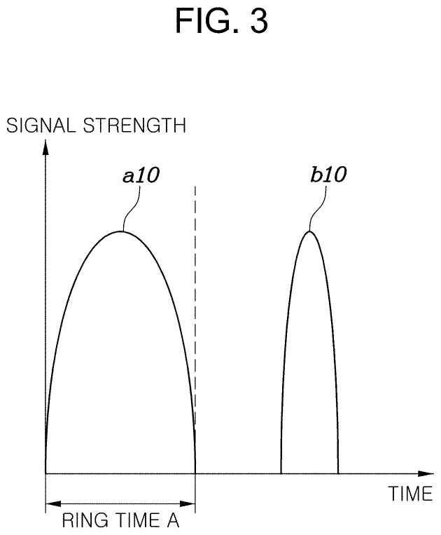

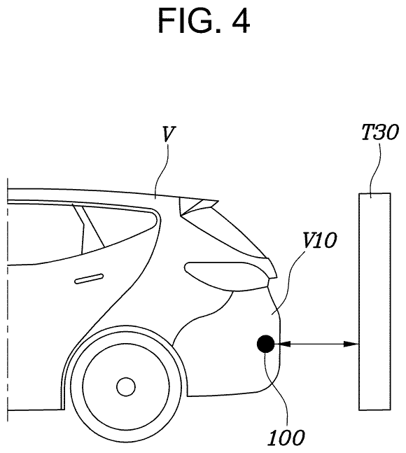

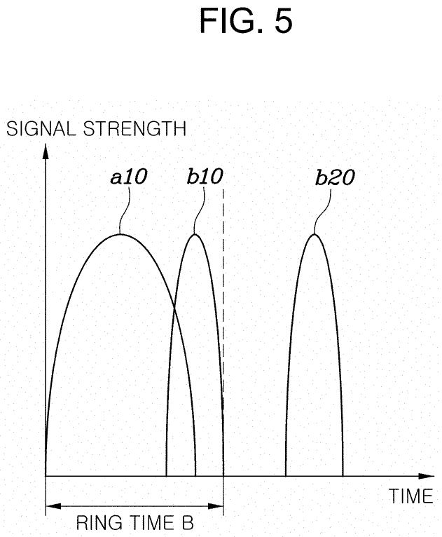

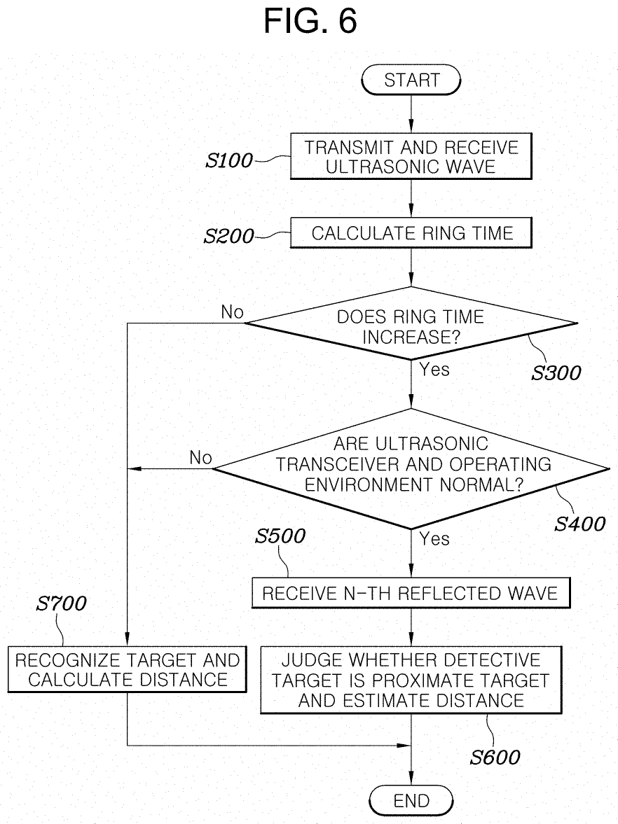

FIG. 1 is a view illustrating a configuration of a vehicle ultrasonic sensor according to an embodiment of the present invention; FIGS. 2 and 3 are views illustrating a general detecting process by a vehicle ultrasonic sensor and a control method thereof according to an embodiment of the present invention; FIGS. 4 and 5 are views illustrating a process of detecting a proximate target by a vehicle ultrasonic sensor and a control method thereof according to an embodiment of the present invention; FIG. 6 is a flowchart of a control method of a vehicle ultrasonic sensor according to an embodiment of the present invention.

According to an embodiment of the present invention, the control unit may be implemented through a processor (not illustrated) configured to control operations described below using a nonvolatile memory configured to store data on the algorithm configured to command operations of various components of a vehicle or software commands to execute the algorithm and the data stored in the memory. Here, the memory and processor may be implemented as separate chips. Alternatively, the memory and processor may be implemented as a single integrated chip, and the processor may take the form of one or more processors.

FIG. 1 is a view illustrating a configuration of a vehicle ultrasonic sensor according to an embodiment of the present invention. The vehicle ultrasonic sensor 100 includes an ultrasonic transceiver 120; a storage unit 140 storing a normal ring time of a received ultrasonic wave; a control unit 180 determining a distance to a target based on a transmitted and received ultrasonic wave and determining the detected target to be a proximate target within a certain distance from the ultrasonic transceiver 120 when the ring time of the received ultrasonic wave is greater than the normal ring time in the storage unit 140.

An object of the present invention is to provide an ultrasonic sensor that allows an accurate recognition of a target and calculation of a distance to the target through an analysis of an ultrasonic sensor ring time and prevention of an erroneous recognition by distinguishing causes of the increased ring time even when the target is located in proximity.

To achieve the object, the ultrasonic sensor 100 of the present invention is provided with the transceiver 120 configured to both transmit and receive the ultrasonic wave. In this case, there is a possibility to erroneously sense the residue of the transmitted ultrasonic wave as a received ultrasonic wave. However, the present invention is not limited to the integrated transceiver but may include a case in which a receiver, located near the transmitter, is subject to the influence of the transmitter even when the transmitter and receiver are separately provided.

On the other hand, the storage unit 140 is provided as a separate memory. The storage unit 140 may generally store the normal ring time generated when an ultrasonic wave is transmitted. The ring time is defined as a time it takes all the residue to disappear after transmission by the ultrasonic sensor and is termed as a residue time, and even if a reflected wave is received, the received wave may not be distinguished from the residue of the transmitted wave during the ring time, thereby generating a blind zone.

When an object is located relatively far away, the reflected wave is received sufficiently long after the ring time is over so that the first reflected wave may be distinguished from the transmitted wave, and thus, the distance to the target may be calculated using the time difference.

However, when the target is located in very close proximity or the vehicle speed is very high, the reflected wave is already received before the ring time of the transmitted wave is over so that the transmitted wave and the received wave overlap each other and distinguishing between the two is difficult. Therefore, under such a circumstance, the ring time inevitably increases.

The present invention captures this characteristic, and it is determined that, when the ring time of the transmitted wave exceeds the normal ring time, that is, the normal ring time stored in the storage unit 140, the increased ring time is caused by the target being a proximate target located very close to the vehicle so that the control unit 180 goes through a correction and recognizes the target to be a proximate target even though the calculation indicates that target is at an ordinary distance.

Accordingly, the control unit 180 determines the distance to the target based on the transmitted and received ultrasonic wave and judges the target to be a proximate target within a certain distance from the ultrasonic transceiver when the ring time of the received ultrasonic wave exceeds the normal ring time in the storage unit.

FIGS. 2 to 5 will be referred to for a more detailed description.

FIGS. 2 and 3 are views illustrating a general process of detecting a target by a vehicle ultrasonic sensor and a control method thereof according to an embodiment of the present invention.

When a target T10 is located at an ordinary distance, farther than a close distance, from the vehicle V as illustrated in FIG. 2, the first reflected wave b10 is received after the residue of the transmitted wave a10 transmitted from the ultrasonic sensor all disappears, that is, after all the ring time is over as illustrated in FIG. 3. Accordingly, in such a case, the transmitted wave a10 and the received wave b10 do not overlap each other, the ring time A is also normal, and the distance is also accurately calculated.

On the other end, FIGS. 4 and 5 are views illustrating a process of a proximate target by a vehicle ultrasonic sensor and a control method thereof according to an embodiment of the present invention.

In this case, a target T30 is located at a very close distance as illustrated in FIG. 4. In such a case, the first reflected wave b10 is received before the residue of the transmitted wave a10 all disappears, that is, before its own ring time is over as illustrated in FIG. 5 so that the control unit 180 has difficulty distinguishing between the transmitted wave a10 and the received wave b10 and that the waves in the overlapping interval may be all recognized as a residue of the transmitted wave a10 and consequently the ring time B in which the residue disappears is perceived to be very long as illustrated in FIG. 5. Accordingly, in this case, the ring time B increases, and the increased ring time B is inevitably greater than the normal ring time A in FIG. 3.

In this case, the control unit 180 does not calculate the distance to the target based on the reflected wave b20 erroneously recognized as the first wave but goes through a correction and recognizes the target to be a proximate target located closer, thereby preventing an erroneous recognition of the sensor.

That is, the control unit 180 may monitor the ring time upon receiving the ultrasonic wave and continuously compare the monitored ring time with the normal ring time in the storage unit. Accordingly, normal distance calculations are performed in normal times and the target is quickly recognized as a proximate target immediately when the ring time increases, thereby ensuring quick responsiveness and accuracy of the sensor.

On the other hand, when the ring time of the ultrasonic wave received while the vehicle is on the move exceeds the normal ring time in the storage unit, the control unit 180 may recognize the ultrasonic wave received after the ring time as an N-th reflected wave. And the control unit may estimate the distance to the target based on the N-th reflected wave received after the ring time.

That is, even when the first reflected wave b10 is received as illustrated in FIG. 5, the control unit 180 has difficulty accurately recognizing the received wave as the reflected wave, and thus, identifies the received wave with the transmitted wave a10 and performs the calculation of the ring time accordingly. As a result, the ring time increases, and the control unit 180 recognizes the target to be a proximate target accordingly. And the distance to the target may be accurately estimated by recognizing the reflected wave received after the ring time B is over as a second reflected wave b20, that is, the wave reflected again from the target and received by the sensor and estimating the time it takes the first reflected wave to reach the transceiver backward by dividing in half the time of the second wave b20.

The calculation of the distance to the target needs time difference between the transmitted wave and the first received wave and the exact time of the first reflected wave b10 is not known in FIG. 5 so that the time of the first reflected wave b10 is estimated backward using the time of the second reflected wave b20 received later and the distance to the proximate target is estimated using the estimated time.

Accordingly, according to this process, not only may the proximate target T30 be accurately and quickly detected, but also the distance may be accurately and quickly estimated, thereby greatly improving the reliability of a parking assistance system, autonomous driving system, and the like.

On the other hand, a plurality of ultrasonic transceivers 120 may be provided at a plurality of points in the vehicle, and the control unit may recognize the ultrasonic wave received after the ring time as the N-th wave for the ultrasonic transceivers mounted on a surface of a certain area or more.

Specifically, a plurality of ultrasonic transceiver 120 may be provided at a plurality of points in the vehicle, and the control unit may recognize the ultrasonic waves received after the ring time as the N-th wave for the ultrasonic transceiver mounted on a vehicle panel including a door or a bumper V10.

Recognition of the N-th reflected wave (here, N is an integer of two or more) by the ultrasonic transceiver 120 needs the implementation of the environment in which the ultrasonic wave is reflected again between the vehicle and the target. Accordingly, the calculation of the distance to the target using the N-th reflected wave needs the environment in which the N-th reflected wave may be implemented. Accordingly, the reliability may be secured when the ultrasonic sensor is mounted on a relatively wide and even panel. Accordingly, it will be difficult to employ the ultrasonic sensor mounted at an uneven point such as a radiator grille, and the distance may be accurately calculated when the ultrasonic sensor is mounted on a panel having a certain area.

Accordingly, when it comes to calculating the distance to the proximate target based on the reflected wave, it will be preferable that only the ultrasonic sensor mounted on the panel is employed, while any ultrasonic sensor may be employed in distinguishing the proximate target.

Further, the ultrasonic sensor of the present invention may further include a monitoring unit 160 monitoring the frequency or impedance of the ultrasonic transceiver or the operating environment, and the control unit 180 may judge the detected target to be a proximate target within a certain distance from the ultrasonic transceiver when the ultrasonic transceiver or the operating environment is determined to be normal based on the information of the monitoring unit 160 and the ring time of the ultrasonic wave exceeds the normal ring time.

The ring time may change when the target is in proximity as well as when the sensor deteriorates or the surrounding temperature or humidity changes. The ability to sort out the causes is necessary.

A resonant circuit in series and a resonant circuit in parallel coexist in the ultrasonic sensor, and accordingly, the ring time may increase when the circuit characteristic changes due to the outside temperature or other causes and mismatching between the sensor cell and circuit occurs (mismatching occurs by a change of capacitance or reactance value mainly caused by outside temperature change and the like) and when the sensor characteristic deteriorates by sensor aging caused by extended use. For example, when the sensor surface is covered with dirt, foreign matters, and the like or covered with ice, the frequency characteristic and equivalent circuitry change.

Accordingly, an erroneous recognition may be prevented by judging that the target is in proximity when an investigation into the causes of the increased ring time ensures normality of the sensor or environment instead of judging the object to be in proximity when the ring time turns out to be longer than usual.

Accordingly, a normal resonant frequency and a normal impedance of the ultrasonic transceiver is stored in the storage unit 140, and the control unit 180 may determine whether the ultrasonic transceiver is normal by comparing the resonant frequency and impedance of the ultrasonic transceiver 120 monitored through the monitoring unit 160 with the normal resonant frequency and normal impedance.

Further, the storage unit 140 may be provided with a data map concerning the temperature and normal ring time, and the control unit 180 may obtain the normal ring time through the data map at a temperature monitored through the monitoring unit 160 and determine whether the operating environment is normal by comparing the obtained normal ring time with the ring time of the ultrasonic wave. As for the temperature, the temperature of the sensor may be measured or the atmospheric temperature outside the vehicle may be measured. And the measured temperature is substituted into the data map to obtain the normal ring time at the measured temperature, and the obtained normal ring time is compared with the measured ring time to determine whether the target is in proximity.

The proximate target may be accurately picked out through this configuration and the erroneous recognition of the proximate target influenced by the sensor or environment may be prevented.

FIG. 6 is a flowchart of a control method of the vehicle ultrasonic sensor according to an embodiment of the present invention.

The method of controlling the ultrasonic sensor of the present invention includes transmitting an ultrasonic wave through an ultrasonic transceiver (S100); receiving an ultrasonic wave through the ultrasonic transceiver (S100); calculating, by a control unit, a ring time of the received ultrasonic wave (S200); comparing the ring time calculated by the control unit with a normal ring time stored in the storage (S300); and judging the detected target to be a proximate target within a certain distance from the ultrasonic transceiver when the ring time calculated by the control unit exceeds the normal ring time (S300, S600).

And, in the judging of a detected target to be a proximate target, the control unit may recognize the ultrasonic wave received after the ring time as N-th reflected wave when the ring time of the ultrasonic wave received while the vehicle is on the move exceeds the normal ring time in the storage unit (S500).

Further, the control unit may estimate the distance to the target based on the N-th reflected wave received after the ring time (S600).

On the other hand, in the judging of a detected target to be a proximate target, the control unit may judge the detected target to be the proximate target within a certain distance from the ultrasonic transceiver when the ultrasonic transceiver or the operating environment is normal and the ring time of the ultrasonic wave exceeds the normal ring time (S400).

In particular, the control unit may determine whether the ultrasonic transceiver is normal by comparing the resonant frequency and impedance of the ultrasonic transceiver with the normal resonant frequency and normal impedance (S400).

Here, the control unit may determine whether the operating environment is normal by comparing the normal ring time obtained through the data map at the measured temperature with the ring time of the ultrasonic wave (S400). When it is determined that the operating environment is not normal, the control unit recognizes the detected target as an ordinary target rather than the proximate target and calculates the distance.

According to the ultrasonic sensor for the vehicle and the control method thereof of the present invention, an analysis of the ultrasonic sensor ring time allows an accurate recognition of a target, calculation of a distance to the target, and prevention of an erroneous recognition by distinguishing causes of the increased ring time even when the target is located in proximity.

The specific embodiments of the present invention are illustrated and described, but it will be self-evident to those skilled in the art that the present invention may be improved upon and modified in various ways within the scope not departing from the technical spirit of the present invention provided by the patent claims below.

What is claimed is:

1. An ultrasonic sensor for a vehicle, comprising:
an ultrasonic transceiver;
a storage unit storing a normal ring time of a received ultrasonic wave; and
a control unit determining a distance to a target based on a transmitted and received ultrasonic wave and determining that a detected target is a proximate target within a certain distance from the ultrasonic transceiver when a ring time of the received ultrasonic wave exceeds the normal ring time.

2. The ultrasonic sensor of claim 1, wherein the control unit monitors the ring time upon receiving the ultrasonic wave and continuously compares the monitored ring time with the normal ring time.

3. The ultrasonic sensor of claim 1, wherein the control unit recognizes the ultrasonic wave received after the ring time as an N-th reflected wave when the ring time of the ultrasonic wave received while the vehicle is moving exceeds the normal ring time.

4. The ultrasonic sensor of claim 3, wherein the control unit estimates the distance to the target based on the N-th reflected wave received after the ring time.

5. The ultrasonic sensor of claim 3, wherein a plurality of ultrasonic transceivers are provided at a plurality of points in the vehicle, and the control unit recognizes the ultrasonic wave received after the ring time as the N-th reflected wave for an ultrasonic transceiver mounted on a surface of a certain area among the plurality of ultrasonic transceivers.

6. The ultrasonic sensor of claim 3, wherein a plurality of ultrasonic transceivers are provided at a plurality of points in the vehicle, and the control unit recognizes the ultrasonic wave received after the ring time as the N-th reflected wave for an ultrasonic transceiver mounted on a vehicle panel including a door or a bumper among the plurality of ultrasonic transceivers.

7. The ultrasonic sensor of claim 1, further comprising a monitoring unit monitoring a frequency or impedance of the ultrasonic transceiver or operating environment,
wherein the control unit determines that the detected target is the proximate target within the certain distance from the ultrasonic transceiver when the ultrasonic transceiver or operating environment is determined to be normal based on information of the monitoring unit and the ring time of the ultrasonic wave exceeding the normal ring time.

8. The ultrasonic sensor of claim 7, wherein a normal resonant frequency and a normal impedance of the ultrasonic transceiver are stored in the storage unit, and the control unit determines whether the ultrasonic transceiver is normal by comparing the resonant frequency and impedance of the ultrasonic transceiver monitored through the monitoring unit with the normal resonant frequency and the normal impedance.

9. The ultrasonic sensor of claim 7, wherein the storage unit is provided with a data map concerning temperature and normal ring time, and the control unit obtains the normal ring time through the data map at a temperature monitored through the monitoring unit and determines whether the operating environment is normal by comparing the obtained normal ring time with the ring time of the ultrasonic wave.

10. A control method for an ultrasonic sensor of a vehicle, the method comprising:
transmitting an ultrasonic wave using an ultrasonic transceiver;
receiving an ultrasonic wave from the ultrasonic transceiver;
calculating, by a control unit, a ring time of the received ultrasonic wave;
comparing the ring time calculated by the control unit with a normal ring time stored in a storage unit; and
determining that a detected target is a proximate target within a certain distance from the ultrasonic transceiver when the ring time calculated by the control unit exceeds the normal ring time.

11. The method of claim 10, wherein, in determining that the detected target is the proximate target, the control unit recognizes an ultrasonic wave received after the ring time as an N-th reflected wave when the ring time of the ultrasonic wave received while the vehicle is moving exceeds the normal ring time.

12. The method of claim 11, wherein the control unit estimates a distance to the target based on the N-th reflected wave received after the ring time.

13. The method of claim 10, wherein, in determining that the detected target is the proximate target, the control unit determines that the detected target is the proximate target within a certain distance from the ultrasonic transceiver when the ultrasonic transceiver or an operating environment is normal and the ring time of the ultrasonic wave exceeds the normal ring time.

14. The method of claim 13, wherein the control unit determines whether the ultrasonic transceiver is normal by comparing a resonant frequency and an impedance of the ultrasonic transceiver with a normal resonant frequency and a normal impedance.

15. The method of claim 13, wherein the control unit obtains the normal ring time through a data map at a measured temperature and determines whether the operating environment is normal by comparing the obtained normal ring time with the ring time of the ultrasonic wave.
